(19) United States
(12) Patent Application Publication
(10) Pub. No.: US 2012/0001416 A1
(43) Pub. Date: Jan. 5, 2012

(54) Retractable Rod Structure

(76) Inventor: I-Sin Peng, Taichung City (TW)

(21) Appl. No.: 12/830,373

(22) Filed: Jul. 5, 2010

(51) Int. Cl. F16L 27/00

(52) U.S. Cl. 285/145.1

(57) ABSTRACT

A retractable rod structure includes an inner pipe, an outer pipe and a positioning unit. The positioning unit includes a sleeve and a resilient engaging plate located in the sleeve. The sleeve has a side wall formed with a first threaded hole and a second threaded hole for engagement of a positioning bolt and a fixing bolt. The sleeve further has a pair of grooves formed on an inner wall of the sleeve close to two sides of the first threaded hole and the second threaded hole. By turning the positioning bolt clockwise or counterclockwise, the resilient engaging plate is controlled to engage with or disengage from the inner pipe for adjustment of the inner pipe. The present invention provides a stepless positioning effect, without wearing the retractable rod, and can be used as a multi-function retractable rod.

### BACKGROUND OF THE INVENTION

1. Field of the Invention

The present invention relates to a retractable rod structure, and more particularly to one having a resilient engaging plate disposed in a positioning unit. By turning a positioning bolt, an inner pipe is retractable relative to an outer pipe, without wearing the inner pipe and providing a larger contact area to secure the inner pipe.

2. Description of the Prior Art

A conventional retractable rod comprises an inner pipe, an outer pipe and a positioning unit to connect the inner pipe and the outer pipe together. By turning the positioning unit clockwise or counterclockwise, the inner pipe is controlled to extend out or retract into the outer pipe for adjusting the length of the retractable rod. There is a gap between the inner pipe and the outer pipe for pulling or pushing the inner pipe. The distal end of the positioning bolt is screwed to hold against the inner pipe so as to position the inner pipe in place, which may scrape and damage the inner pipe. Besides, it is not easy to position the inner pipe because the contact area is small.

### SUMMARY OF THE INVENTION

The primary object of the present invention is to provide a retractable rod structure which comprises an inner pipe, an outer pipe and a positioning unit. The positioning unit comprises a sleeve and a resilient engaging plate. The sleeve has an upper portion and a lower portion in different diameters to receive the inner pipe and the outer pipe, respectively. An annular stop portion is provided between the upper portion and the lower portion to hold against a top edge of the outer pipe. The sleeve has a side wall formed with a first threaded hole and a second threaded hole for engagement of a positioning bolt and a fixing bolt. The sleeve further has a pair of grooves formed on an inner wall of the sleeve close to two sides of the first threaded hole and the second threaded hole. The resilient engaging plate has a curved portion corresponding to the inner pipe and a pair of flanges extending from two sides of the curved portion. By turning the positioning bolt clockwise or counterclockwise, the resilient engaging plate is controlled to engage with or disengage from the inner pipe for adjustment of the inner pipe. The present invention provides a stepless positioning effect, without wearing the retractable rod, and can be used as a multi-function retractable rod.

### BRIEF DESCRIPTION OF THE DRAWINGS

FIG. 1 is an exploded view according to a preferred embodiment of the present invention;

FIG. 2 is a perspective view according to the preferred embodiment of the present invention;

FIG. 3 is a sectional view according to the preferred embodiment of the present invention;

FIG. 4 is a partially sectional view showing a sleeve and a resilient engaging plate according to the preferred embodiment of the present invention; and

FIG. 5 is an exploded view showing the sleeve and the resilient engaging plate according to the preferred embodiment of the present invention.

### DETAILED DESCRIPTION OF THE PREFERRED EMBODIMENTS

Embodiments of the present invention will now be described, by way of example only, with reference to the accompanying drawings.

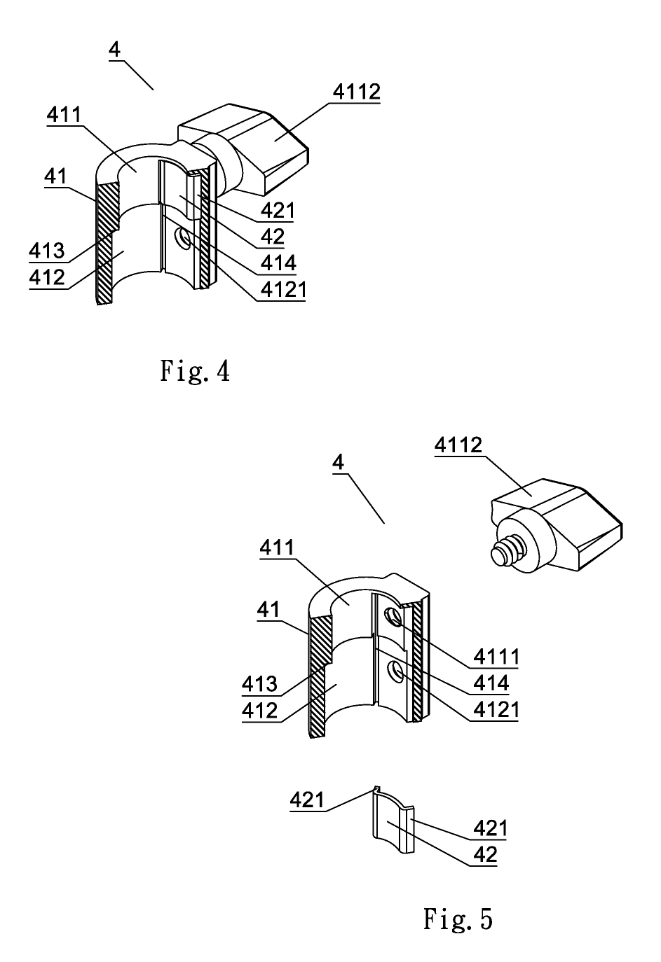

As show in FIG. 1, FIG. 4 and FIG. 5, a retractable rod structure according to a preferred embodiment of the present invention comprises an inner pipe 2, an outer pipe 3, and a positioning unit 4. The inner pipe 2 has an upper end coupled with a connection member and a lower end inserted in the outer pipe 3. The positioning unit 4 is adapted to position the inner pipe 2 and the outer pipe 3 to become a retractable rod.

The connection member on top of the inner pipe 2 can be canvas, a boat lamp, a boat oar, a hook or the like. The inner pipe 2 has an outer diameter slightly smaller than the inner diameter of the outer pipe 3, so that the inner pipe 2 can be retracted in the positioning unit 4 and the outer pipe 3. The positioning unit 4 provides a positioning effect to secure the inner pipe 2 and the outer pipe 3.

The outer pipe 3 has a top end inserted in a lower portion 412 of a sleeve 41 and a top edge abutting against an annular stop portion 413 of the sleeve 41 to receive the inner pipe 2.

The positioning unit 4 comprises the sleeve 41 and a resilient engaging plate 42. The sleeve 41 has an upper portion 411 and the lower portion 412 in different diameters to receive the inner pipe 2 and the outer pipe 3, respectively. The annular stop portion 413 is provided between the upper portion 411 and the lower portion 412 to hold against the top edge of the outer pipe 3. The sleeve 41 has a side wall formed with a first threaded hole 4111 and a second threaded hole 4121 for engagement of a positioning bolt 4112 and a fixing bolt 4122. The sleeve 411 further has a pair of grooves 414 formed on an inner wall of the sleeve 411 close to two sides of the first threaded hole 4111 and the second threaded hole 4121.

The resilient engaging plate 42 has a curved portion corresponding to the inner pipe 2 to be contact with the outer wall of the inner pipe 2. The resilient engaging plate 42 further has a pair of flanges 421 extending from two sides of the curved portion to slide along the pair of grooves 414 of the sleeve 41. The present invention provides a stepless positioning effect, without wearing the retractable rod.

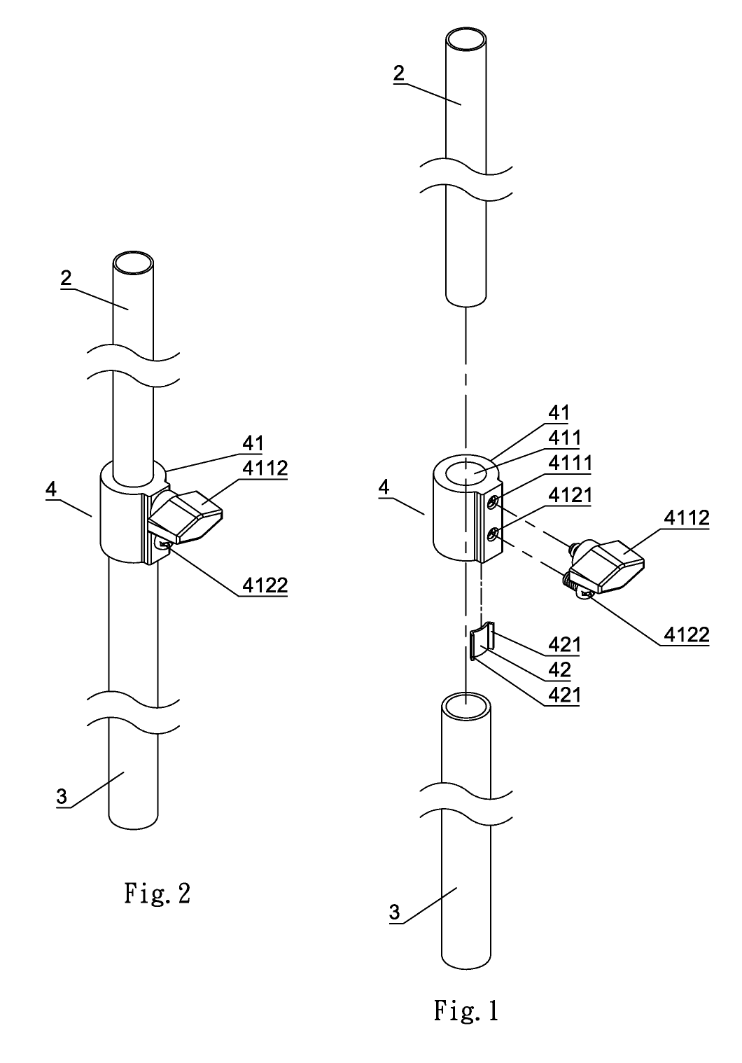

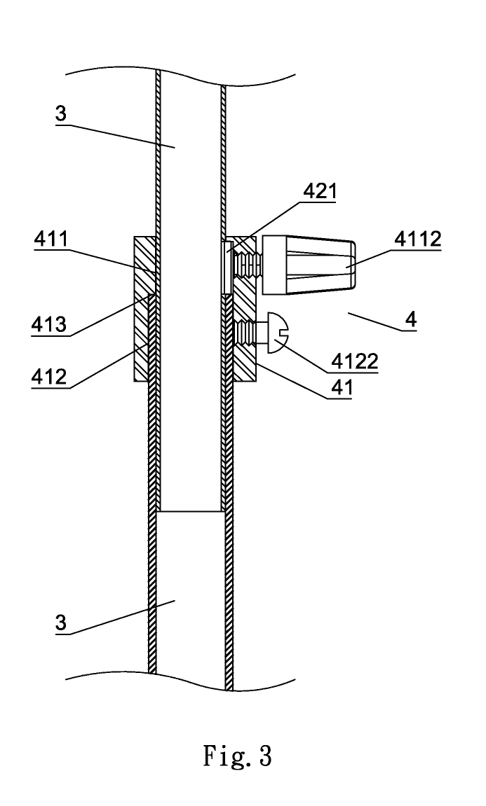

Referring to FIG. 2 and FIG. 3, the pair of flanges 421 of the resilient engaging plate 42 is moved up to the top of the upper portion 411 along the pair of grooves 414. The outer pipe 3 is inserted in the lower portion 412, with its top edge abutting against the annular stop portion 413 and holding against a lower end of the resilient engaging plate 42. The fixing bolt 4122 is inserted through the second threaded hole 4121 to fix the outer pipe 3. By turning the positioning bolt 4112 clockwise or counterclockwise, the inner pipe 2 can be moved upward or downward to be a retractable status. When the positioning bolt 4112 is turned counterclockwise, the resilient engaging plate 42 will be released from the positioning bolt 4112 and the contact surface of the resilient engaging plate 42 will disengage from the inner pipe 2. Thus, the sleeve 41 and the inner pipe 2 are in a loosened status so that the inner pipe 2 can be moved. When the positioning bolt 4112 is turned clockwise, the resilient engaging plate 42 is forced to hold against the inner pipe 2, such that the inner pipe 2 is positioned in place by increasing the indirect contact area. Accordingly, the present invention provides a stepless positioning effect as a multi-function retractable rod, without wearing the retractable rod.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A retractable rod structure, comprising an inner pipe, an outer pipe and a positioning unit, the positioning unit comprising a sleeve and a resilient engaging plate, characterized by:
the sleeve having an upper portion and a lower portion in different diameters to receive the inner pipe and the outer pipe, respectively, an annular stop portion being provided between the upper portion and the lower portion to hold against a top edge of the outer pipe, the sleeve having a side wall formed with a first threaded hole and a second threaded hole for engagement of a positioning bolt and a fixing bolt, the sleeve further having a pair of grooves formed on an inner wall of the sleeve close to two sides of the first threaded hole and the second threaded hole;
the resilient engaging plate having a curved portion corresponding to the inner pipe and a pair of flanges extending from two sides of the curved portion;
thereby, by turning the positioning bolt clockwise or counterclockwise, the resilient engaging plate being controlled to engage with or disengage from the inner pipe for adjustment of the inner pipe.
